(19) United States
(12) Patent Application Publication
(10) Pub. No.: US 2010/0209652 A1
(43) Pub. Date: Aug. 19, 2010

(54) METHOD FOR REMEDYING DEFECT OF GLASS SUBSTRATE, METHOD FOR MANUFACTURING GLASS SUBSTRATE, GLASS SUBSTRATE FOR DISPLAY PANEL, AND DISPLAY PANEL

(76) Inventors: Takenori Yoshizawa, Osaka (JP); Yasufumi Mizukami, Tokyo (JP); Toshihiko Shibuya, Miyagi (JP)

Correspondence Address: NIXON & VANDERHYE, PC, 901 NORTH GLEBE ROAD, 11TH FLOOR, ARLINGTON, VA, 22203, US

(21) Appl. No.: 12/669,655

(22) PCT Filed: Jul. 11, 2008
(86) PCT No.: PCT/JP2008/062620

§ 371 Date: Jan. 19, 2010

(30) Foreign Application Priority Data
Oct. 1, 2007 (JP) 2007-257712

(51) Int. Cl. B32B 3/10; C03C 19/00; B32B 17/00; B32B 3/02; B24C 1/00; B24B 1/00

(52) U.S. Cl. 428/63; 65/61; 428/156; 451/38; 451/41

(57) ABSTRACT

According to a method of the present invention for remedying a defect of a glass substrate, abrasive grains (12a) made of alumina are jetted toward a protrusion (1p) which is located in a portion where an internal bubble (1b) is formed in a glass substrate (1) so that a glass material in a region including the internal bubble (1b) is removed. Thus, it is possible to completely remedy the internal bubble (1b) of the glass substrate (1) without damaging the glass substrate (1).

### TECHNICAL FIELD

The present invention relates to remedying a defect of a glass substrate which will constitute a display panel.

### BACKGROUND ART

A glass substrate is often used as a substrate constituting a flat display panel such as a liquid crystal panel or a plasma display panel (PDP). Demands for the glass substrate for a flat display (hereinafter referred to simply as “glass substrate”) have been becoming more and more severe as enlargement of display has been accelerated in recent years.

One of the demands for the glass substrate is a reduction in glass substrate defect. Here, what is meant by the term “glass substrate defect” is an internal defect such as an internal bubble or an internal foreign matter, and a surface defect such as a protrusion or a scratch formed on a surface of the glass substrate.

A flat display manufactured with the use of a glass substrate having a defect causes a display defect such as a bright dot or a black dot in the vicinity of the defect. On this account, it is preferable that a glass substrate include as little defects as possible.

The following description deals with how a defect of a glass substrate occurs.

In a process of melting a glass material in producing a glass substrate, air comes into the material or a gas is emitted from a fire-resisting material, thereby causing a bubble in the melted glass material. As such, an internal bubble is caused. Further, there are some glass materials to be used that generate a gas themselves. Such internal bubbles exist at a certain ratio depending on a volume, and it is not easy to decrease the ratio. In a case where a bubble existing inside a glass substrate is located close to a surface of the glass substrate, the glass substrate may include a protrusion (including a projection or an undulation) on the surface thereof.

An internal foreign matter is caused due to (i) a raw material, or (ii) contamination from outside. The internal foreign matter caused due to a raw material includes (a) a case where a glass material is not melted and remains as a foreign matter, and (b) a case where a material that is not easily melted is mixed in a glass material. Further, the contamination from outside includes a case where a fire-resisting material that has been used for melting a glass material is mixed in the glass material and remains as a foreign matter. In a case where such a foreign matter existing inside the glass substrate is located close to a surface of the substrate, the glass substrate may include a protrusion (including a projection or an undulation) on the surface of the glass substrate, similarly to the internal bubble.

A protrusion formed on the surface of the glass substrate is, as has been already described, a surface defect that is caused due to an internal bubble or internal foreign matter.

Further, a scratch formed on the surface of the glass substrate is caused such that, in a processing step of carrying out an edge process with respect to glass substrates cut out from a large glass plate, which is called a primitive plate, the glass substrates come into contact with each other.

Here, though this is not the one for dealing with the glass substrate defects, there has been known a technique for eliminating a bright dot defect, in which technique a recess is formed on a region corresponding to a defective pixel in a glass substrate, and a light-shielding resin is filled into the recess, so that leakage of light is prevented (see Patent Documents 1 and 2).

Further, there has been also known a polishing apparatus for removing a very small protrusion by grinding the protrusion formed in a color filter of a liquid crystal display panel (see, for example, Patent Document 3).

### CITATION LIST

Patent Literature 1

Japanese Patent Application Publication, Tokukaihei, No. 5-210074 A (Publication Date: Aug. 20, 1993)

Patent Literature 2

Japanese Patent Application Publication, Tokukai, No. 2005-189360 A (Publication Date: Jul. 14, 2005)

Patent Literature 3

Japanese Patent Application Publication, Tokukaihei, No. 6-313871 A (Publication Date: Nov. 8, 1994)

### SUMMARY OF INVENTION

Such a glass substrate defect can cause a display defect in a flat display.

For example, in a case where an internal bubble having a certain degree of size (for example, a diameter is not less than 100 μm) exists in a glass substrate, a region in the vicinity of the bubble is observed as a bright dot. Although a mechanism of how a bright dot occurs due to such an internal bubble is not necessarily clear, it is considered that, because the internal bubble exists, a lens effect is caused due to a glass around the internal bubble, or a scattered polarization state is caused due to a residual stress of the glass around the internal bubble, thereby causing such a bright dot.

Further in a case where an internal foreign matter having a certain degree of size exists in a glass substrate, and the internal foreign matter is made of a light-shielding material, a black dot may occur.

Furthermore, in a case of a surface defect such as a protrusion or a scratch, a minute refracting surface or reflecting surface is formed in a direction different from that of a surface of a glass substrate. As a result, a bright dot due to them can occur.

Although, from the viewpoint of a display quality, it is ideal to use a glass substrate having no defect, it is impossible to produce such a glass substrate. Further, even if the occurrence of defects can be reduced to a certain degree by improving a production process of a glass substrate, there is a limit.

On the other hand, in a case where all glass substrates including defects that may cause a display defect are regarded as defective products, problems such as a reduction in production yield and an increase in cost of a glass substrate and a flat display may arise. Especially in a large glass substrate for a large display, the reduction in production yield is a serious problem because the large glass substrate is stochastically likely to include such a defect.

From these reasons, a technique in which, even if a produced glass substrate includes a defect, the defect is remedied so that a good-quality product is produced, is required.

Such a requirement for the technique is common for glass substrates that constitute a flat display panel such as a liquid crystal display panel or a plasma display panel. From the following reason, the technique is more significantly required for the glass substrate for a liquid crystal display panel.

In the glass substrate for a liquid crystal display panel, it is necessary to provide a semiconductor element on its surface, and the semiconductor element easily receives a bad influence from an alkali metal. From this reason, it is general to use, for the glass substrate for a liquid crystal display panel, a non-alkali glass that does not include the alkali metal as an additive component (the alkali metal as an impurity is not more than 1%). However, since a melting point of the non-alkali glass is high, in a case where the non-alkali glass is used, while a glass material is melted, a bubble does not easily come out from the material, thereby resulting in that the bubble tends to remain inside as an internal bubble. As such, the glass substrate for a liquid crystal display panel tends to include a defect as the internal bubble. In view of this, the technique for producing a good-quality product especially by remedying such a defect is particularly highly required for the glass substrate for a liquid crystal display panel.

The present invention was accomplished in view of the above problems. An object of the present invention is to provide a technique for remedying a defect in a glass substrate which will constitute a display panel.

The above problems may be solved, for example, by grounding, with a drill, a glass material in a region where a defect of a glass substrate exists. However, according to this method, it is difficult to completely remove glass around a bubble although the region where the defect exists can be removed to some extent.

Further, a defect of a glass substrate can be completely remedied, for example, by grounding, with a grinding stone, a glass material in a region where the defect exists is ground. However, since the grinding stone directly makes contact with the glass substrate, pressure from the grinding stone on the glass substrate and processing heat due to friction between the grinding stone and the glass substrate may damage the glass substrate.

In view of this, as a result of diligent studies, the inventors of the present invention found that abrasive grain blasting in which powder such as abrasive grains is jetted toward a glass substrate is effective as a method for completely remedying a defect of the glass substrate without damaging the glass substrate. Note that fluid or fluid containing powder may be jetted instead of the powder.

In order to attain the above object, a method of the present invention for remedying a target defect of a glass substrate for constituting a display panel, comprising: removing a glass material in a region including the target defect, by jetting at least one of powder and fluid toward a portion where the target defect is located.

According to the arrangement, in which a glass material in a region including the target defect is removed by jetting at least one of powder and fluid toward a portion where the target defect is located, it is possible to easily and completely remedy the target defect of the glass substrate without causing damage on the glass substrate.

Specifically, according to the defect remedying method arranged as above, the grinding process progresses by accumulation of microfabrication processes in which the jetted powder or fluid collides with the glass substrate in the region including the target defect. This allows the glass substrate to be finely processed (ground), thereby making it possible to easily adjust an amount of the glass material to be removed. Thus, it is possible to easily and completely remedy the target defect of the glass substrate without causing damage on the glass substrate.

Here, it is possible to improve a display defect due to the target defect by removing a glass material in a region including the target defect.

The target defect includes an internal defect (e.g. an internal bubble) formed in a glass substrate, and a surface defect (e.g. a protrusion or a scratch) formed on a surface of the glass substrate.

It is preferable that, in a case where the target defect is an internal defect formed in the glass substrate, the step of removing removes the glass material, from a surface of the glass substrate to the internal defect at least, by jetting at least one of the powder and the fluid toward a portion where the internal defect is located.

Further, it is preferable that the step of removing also removes a glass material surrounding the internal defect.

According to the method, a glass material, from a surface of the glass substrate to the internal defect, is removed and a glass material surrounding the internal defect is removed, i.e., a glass material placed on a lateral side and a backside of the internal defect is removed. This further reduces the lens effect and the scattered polarization state.

Meanwhile, it is preferable that, in a case where the target defect is a protrusion formed on the glass substrate, the step of removing removes the glass material so that a surface of the glass substrate is planarized by jetting at least one of the powder and the fluid toward a portion where the protrusion is located,.

According to the method, the glass material is removed by jetting at least one of powder and fluid toward the protrusion so that the protrusion is planarized. The planarization of the protrusion means that the height of the protrusion is lowered by removing a part of or all of the protrusion. In a case where the protrusion is planarized, a small recess may be formed in a part where the protrusion was located.

This allows to approximate the surface on which the protrusion is formed, to a primary surface shape. As a result, a bright dot due to the protrusion hardly occurs.

As described above, according to the method, it is possible to remedy a surface defect of a glass substrate so that a display defect due to the surface defect of the glass substrate can be improved.

Further, it is preferable that, in a case where the target defect is a scratch formed on the glass substrate, the step of removing removes the glass material so that a surface of the glass substrate is smoothed by jetting at least one of the powder and the fluid toward a portion where the scratch is located.

According to the method, a glass material is removed by jetting at least one of powder and fluid so that the surface of the glass substrate on which the scratch is formed is smoothed. Smoothing the surface on which the scratch is formed means that an angle defined between a primary surface of the glass substrate and a surface formed due to the scratch is reduced.

This allows to approximate the surface on which the scratch is formed, to a primary surface shape. As a result, a bright dot due to the scratch hardly occurs.

As described above, according to the method, it is possible to remedy a surface defect of a glass substrate so that a display defect due to the surface defect of the glass substrate can be improved.

It is preferable that the step of removing also removes a glass material surrounding the protrusion or the scratch formed on the surface of the glass substrate.

According to the method, in which a glass material surrounding the protrusion or the scratch formed on the surface of the glass substrate is also removed, it is possible to further reduce the lens effect and the scattered polarization state.

It is preferable that the powder is alumina. This alumina has hardness (Mohs hardness) of 9, and can be suitably used as abrasive grains for grinding.

Since the powder jetted to a portion where the target defect of the glass substrate is located remains in the portion, the powder that remains in the portion hinders subsequently jetted powder from grinding the portion, and the longer the powder continue to be jetted, the lower grinding efficiency becomes.

In view of this, in a case where the glass material is removed by jetting the powder, in the step of removing, (i) air which contains the powder and (ii) only air are jetted alternately, the air serving as a medium for jetting of the powder.

According to the method, in which grinding of a portion to be remedied in the glass substrate and removal of a material (e.g. powder) which remains in the portion are alternately carried out, it is possible to prevent unnecessary powder from remaining in the portion. As a result, it is possible to improve grinding efficiency.

It is preferable that a portion from which the glass material is removed is filled with a transparent material.

According to the method, in which a portion (e.g. recess or groove) from which the glass material is removed is filled with a transparent material (solid substance), it is possible to reduce a change in refractive index, compared with a state where the portion is not filled. This allows the portion from which the glass material is removed to be hardly observed.

In the defect remedying method, the glass substrate may be for constituting a liquid crystal display panel.

Since a glass substrate for constituting a liquid crystal display panel contains less alkali metal and its melting point is high, an internal bubble easily occurs. In this regard, the method for removing the internal defect is especially effective for the glass substrate for constituting a liquid crystal display panel.

Note that each of the defect remedying methods described above can also be seen as a method for manufacturing a glass substrate.

A method of the present invention for manufacturing a glass substrate for constituting a display panel, includes removing a glass material in a region including a target defect formed on the glass substrate by jetting at least one of powder and fluid toward a portion where the target defect is located.

It is preferable that, in a case where the target defect is an internal defect (e.g. internal bubble) formed in the glass substrate, the step of removing removes the glass material, from a surface of the glass substrate to the internal defect at least, by jetting at least one of the powder and the fluid toward a portion where the internal defect is located.

It is preferable that the step of removing also removes a glass material surrounding the internal defect.

Further, it is preferable that, in a case where the target defect is a protrusion formed on the glass substrate, the step of removing removes the glass material so that a surface of the glass substrate is planarized by jetting at least one of the powder and the fluid toward a portion where the protrusion is located.

Further, it is preferable that, in a case where the target defect is a scratch formed on the glass substrate, the step of removing removes the glass material so that a surface of the glass substrate is smoothed by jetting at least one of the powder and the fluid toward a portion where the scratch is located.

It is preferable that the step of removing also removes a glass material surrounding the protrusion or the scratch formed on the surface of the glass substrate.

It is preferable that the powder is alumina.

It is preferable that, in a case where the glass material is removed by jetting the powder, in the step of removing, (i) air which contains the powder and (ii) only air are jetted alternately, the air serving as a medium for jetting of the powder.

It is preferable that the method, further includes filling with a transparent material a portion from which the glass material is removed.

It is preferable that the glass substrate is for constituting a liquid crystal display panel.

According to the arrangement, in a surface of a display area of the display panel, which display area is obtained when the display panel is constituted by the glass substrate, the glass substrate includes a region (i) in which a glass material is removed, and (ii) in which a transparency is maintained. With the arrangement, it is possible to replace an internal defect or a surface defect with the region where a transparency is maintained. This can improve a display defect due to the internal defect or surface defect of the glass substrate.

A glass substrate of the present invention is a glass substrate for constituting a display panel, wherein: in a surface of a display area of the display panel, which display area is obtained when the display panel is constituted by the glass substrate, the glass substrate includes a region (i) to which at least one of powder and fluid is jetted so that a removal process in which a glass material is removed is carried out, (ii) in which a transparency is maintained, and (iii) in which a recess is formed.

It is preferable that the recess is filled with a transparent material.

This allows the recess to be hardly observed.

Further, in a case where a display panel is constituted by the glass substrate, a display defect due to an internal defect or a surface defect of the glass substrate can be improved in the display panel.

### BRIEF DESCRIPTION OF DRAWINGS

FIG. 1 (a) through (c) of FIG. 1 each is a cross-sectional view showing how a grinding process in the Embodiment 1 of the present invention progresses.

FIG. 2 is a cross-sectional view showing a substantial part of a glass substrate to be remedied in the Embodiment 1 of the present invention.

FIG. 3 is a cross-sectional view showing an arrangement of a defect remedying apparatus used in the Embodiment 1 of the present invention.

FIG. 4 is a view schematically showing an arrangement of a remedying head provided in the defect remedying apparatus shown in FIG. 3.

FIG. 5 (a) is a cross-sectional view showing a substantial part of the glass substrate that has been subjected to the grinding process.

FIG. 5 (b) is a cross-sectional view showing a substantial part of the glass substrate that has been subjected to the grinding process.

FIG. 6 (a) is a cross-sectional view showing a shape of a processed surface obtained by the grinding process.

FIG. 6 (b) is a cross-sectional view showing a shape of a processed surface obtained by the grinding process.

FIG. 7 is a cross-sectional view showing a state where a recess formed by the grinding process is filled with a transparent material.

FIG. 8 is a cross-sectional view showing a substantial part of another glass substrate to be remedied in the Embodiment 1 of the present invention.

FIG. 9 is a cross-sectional view showing a substantial part of a glass substrate to be remedied in the Embodiment 2 of the present invention.

FIG. 10 (a) through (c) of FIG. 10 each is a cross-sectional view showing how a grinding process in the Embodiment 2 of the present invention progresses.

FIG. 11 is a cross-sectional view showing a substantial part of a glass substrate to be remedied in the Embodiment 3 of the present invention.

FIG. 12 (a) and (b) of FIG. 12 each is a cross-sectional view showing how a grinding process in the Embodiment 3 of the present invention progresses.

FIG. 13 (a) is a plan view showing a liquid crystal display panel of an embodiment of the present invention.

FIG. 13 (b) is a cross-sectional view showing the liquid crystal display panel shown in FIG. 13 (a).

FIG. 14 is a cross-sectional view showing an arrangement of another defect remedying apparatus used in a defect remedying method of the present invention.

FIG. 15 is a view schematically showing an arrangement of another remedying head used in the defect remedying method of the present invention.

### DESCRIPTION OF EMBODIMENTS

### Embodiment 1

Embodiment 1 of the present invention is described below.

A defect remedying method of the present embodiment is a method for remedying a defect of a glass substrate which will constitutes a display panel, the defect being an internal defect formed in the glass substrate.

The defect remedying method of the present embodiment can be applied to a glass substrate which will constitute various display panels such as a liquid crystal display panel, a plasma display panel (PDP), and the like.

Further, the defect remedying method of the present embodiment can be carried out in various stages in producing a glass substrate or a display panel. That is, the defect remedying method of the present embodiment can be carried out, for example: (i) in a stage where a glass substrate has been cut out from a primitive plate by a glass manufacturer but has not been shipped yet; (ii) in a stage where the glass substrate has been received by a manufacturer of a display device but has not been used in a display panel yet; and (iii) in a stage where a display panel constituted by use of the glass substrate has been checked but has not been assembled as a display device yet. Especially, in the case where the defect remedying method of the present embodiment is carried out with respect to a glass substrate that has been cut out from a primitive plate by a glass manufacturer but has not been shipped yet, the defect remedying method of the present embodiment is carried out as one process in a method of producing a glass substrate.

In the following explanation, it is assumed that a glass substrate is the one for a liquid crystal display panel, and the defect remedying method is carried out in the stage where a display panel constituted by use of the glass substrate has been checked but has not been assembled as a display device yet. Further, it is assumed herein that the internal defect is an internal bubble. As such, the following description deals with a method for remedying an internal bubble.

Note that, since a glass substrate which will constitute a liquid crystal display panel contains less alkali metal and its melting point is high, an internal bubble easily occurs. In this regard, the defect remedying method of the present embodiment is especially effective for the glass substrate for constituting a liquid crystal display panel.

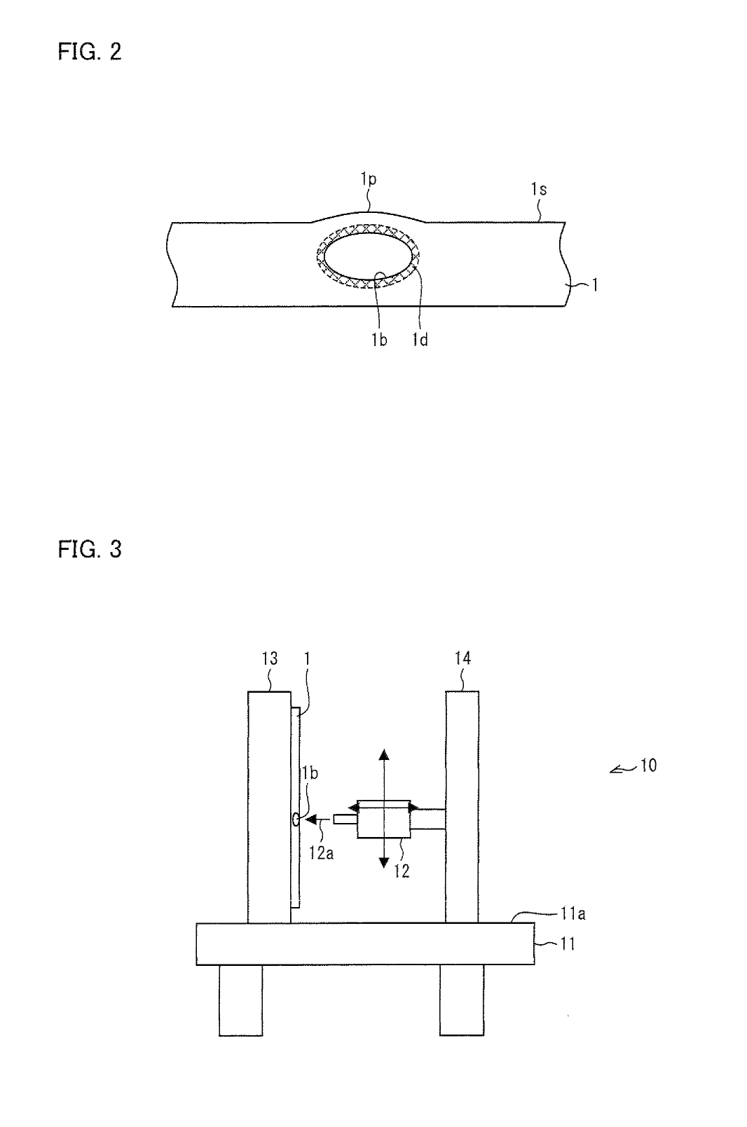

FIG. 2 is a cross-sectional view of a glass substrate 1 in which an internal bubble 1b, which serves as an internal defect to be remedied, is formed.

Since the internal bubble 1b of FIG. 2 has a relatively large size, and its location is relatively near from a surface 1s of the glass substrate 1, the glass substrate 1 includes a protrusion 1p on the surface 1s. The inner bubble 1b may not cause the protrusion 1p depending on the size and location.

The internal bubble 1b can be bubbles with various sizes such as the one whose maximum diameter is not more than 100 μm or is almost the same size as a thickness of the glass substrate 1 (for example, 0.7 mm). In a case of the internal bubble 1b being, for example, not more than 100 μm in maximum diameter, since such a small internal bubble 1b has less effect on a display, it is considered that any special processes may not be required. Further, in a case of the internal bubble 1b being, for example, 100 to 300 μm in maximum diameter, it is considered to carry out a remedying process for the internal bubble 1b to be a black dot. However, in a case of the internal bubble 1b being, for example, more than 300 μm in maximum diameter, there is no conceivable effective methods for sufficiently reducing adverse effects on a display, except for the defect remedying method of the present embodiment as described below.

As such, the defect remedying method of the present embodiment can be carried out with respect to the various internal bubbles 1b from large size to small size. Among such internal bubbles 1b, the defect remedying method of the present embodiment is especially effective for the large-size internal bubble 1b to which any other effective methods are hardly conceivable.

A bright dot is observed due to the internal bobble 1b formed in the glass substrate 1. Although a mechanism of how the bright dot occurs due to such an internal bubble 1b is not necessarily clear, the bright dot may occur from the following reason.

In a case where a liquid crystal display panel is constituted by the glass substrate 1 that contains the internal bubble 1b, a lens effect is caused due to a glass (surrounding section 1d) around the internal bubble 1b, or a scattered polarization state is caused due to a residual stress of the glass around the internal bubble 1b. Thus, a region in the vicinity of the internal bubble 1b is observed as a bright dot.

In view of this, the defect remedying method of the present embodiment is such that a glass material, from the surface 1s of the glass substrate 1 to the internal bubble 1b at least, is removed by jetting abrasive grains toward a portion where the internal bubble 1b, which serves as an internal defect formed in the glass substrate 1, is located.

Further, as shown in FIG. 2, a glass material (hereinafter referred to as “surrounding section”) 1d surrounding the internal bubble 1b is preferably removed together with the internal bubble 1b since a lens effect or a scattered polarization state is caused due to the surrounding section 1d.

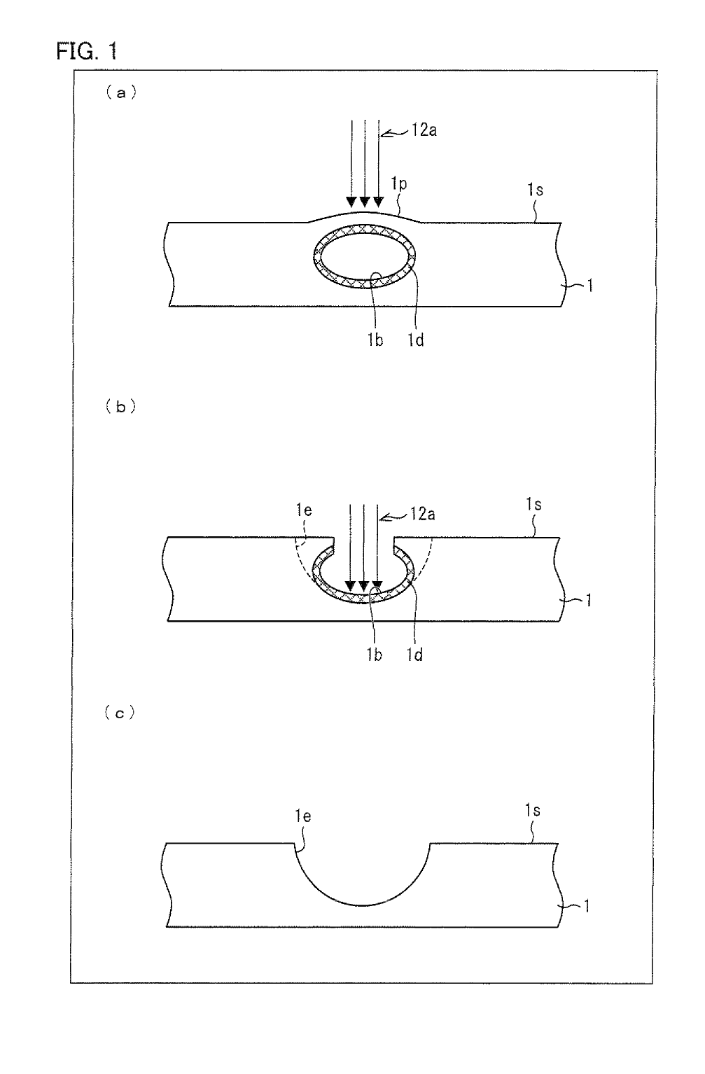

(a) through (c) of FIG. 1 are views respectively illustrating internal defect removing steps according to the defect remedying method of the present embodiment.

As shown in (a) of FIG. 1, abrasive grains 12a are jetted toward the protrusion 1p formed on the surface is of the glass substrate 1 at a predetermined jetting speed. In this case, alumina having a grain size of No. 800 (approximately 0.03 mm) is used as the abrasive grains 12a. The jetting speed of the abrasive grains 12a is set to 0.2 mm/s to 0.6 mm/s.

The abrasive grains 12a are jetted at the predetermined jetting speed so that the glass material constituting the protrusion 1p is removed until the abrasive grains 12a reach the internal bubble 1b (see (b) of FIG. 1). The abrasive grains 12a continue to be jetted so that the internal bubble 1b is ground away by the abrasive grains 12a. Further, the abrasive grains continue to be jetted so that a glass material constituting the surrounding section 1d surrounding the internal bubble 1b is removed until a revised surface 1e is exposed, i.e., until no lens effect and no scattered polarization state are caused (see (c) of FIG. 1).

The grinding process progresses by accumulation of microfabrication processes in which the jetted abrasive grains 12a collide with the glass substrate 1. As such, the glass substrate 1 can be processed finely with high quality.

An apparatus for achieving the defect remedying method of the present embodiment is described below.

FIG. 3 is a cross-sectional view of a defect remedying apparatus 10 for carrying out the defect remedying method of the present embodiment.

The defect remedying apparatus 10 includes a substrate placing table 13 which is provided on a placing surface 11a of a placing table 11 and which fixes the glass substrate 1, which serves as an object to be remedied, vertically with respect to ground; and a head mounting table 14 provided with a remedying head 12 for jetting the abrasive grains 12a toward a remedied portion 1b of the glass substrate 1 fixed on the substrate placing table 13.

The remedying head 12 is provided in the head mounting table 14 so as to be movable horizontally and vertically with respect to the ground, and jets the abrasive grains 12a horizontally with respect to the ground.

Further, the remedying head 12 includes a jetting nozzle (later described) for jetting the abrasive grains 12a which are used to grind the glass substrate 1. The defect remedying apparatus 10 carries out a grinding process as follows. Specifically, the remedying head 12 is moved so as to face the internal bubble lb of the glass substrate 1, and then jets the abrasive grains 12a toward the surface 1s of the glass substrate 1.

The defect remedying method of the present embodiment can be carried out, for example, through the following procedure. First, a liquid crystal display panel is formed by use of a glass substrate 1 in which a defect has not been remedied yet. While the liquid crystal display panel is evenly irradiated by light from its backside, it is checked whether or not a bright dot due to an internal bubble 1b formed in the glass substrate can be observed. In a case where the bright dot is observed, a location thereof is specified. Then, the liquid crystal display panel is placed on the substrate placing table 13 of the defect remedying apparatus 10, and a grinding process (later described) is carried out at the specified location. In a case where a polarization plate is attached on a surface of the glass substrate 1, the polarization plate may be detached once before the grinding process is carried out, and attached to the glass substrate 1 again after the grinding process is completed.

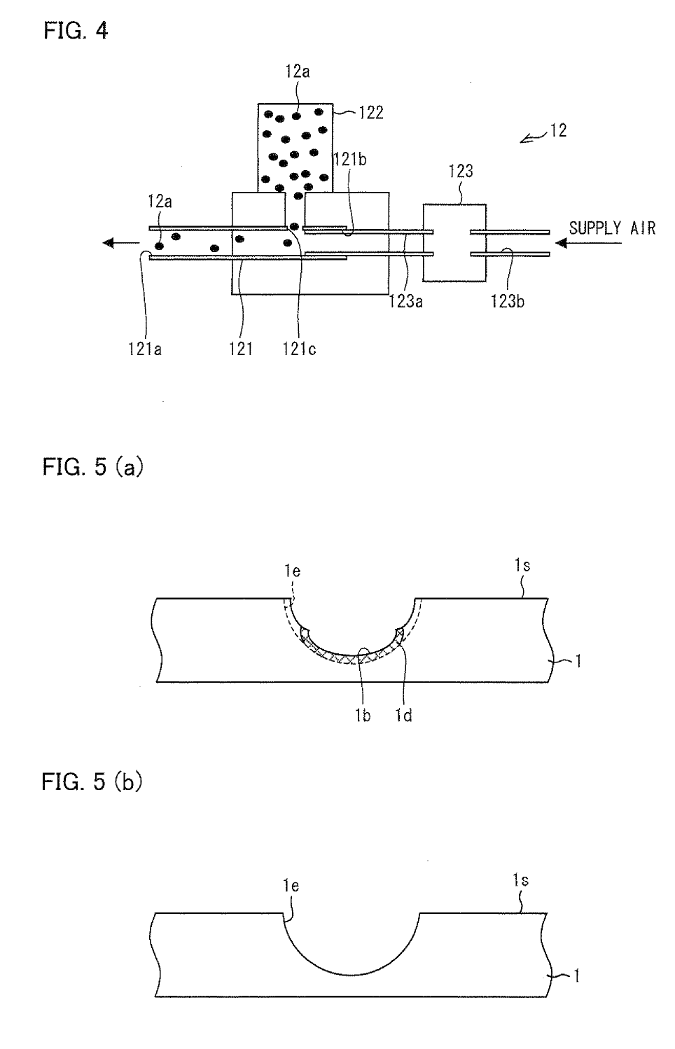

FIG. 4 is a view schematically illustrating the remedying head 12 provided in the defect remedying apparatus 10.

As shown in FIG. 4, the remedying head 12 includes an abrasive grain supplying nozzle 121 for constantly supplying the abrasive grains 12a.

The abrasive grain supplying nozzle 121 has a cylindrical shape, and includes a front hole 121a via which the abrasive grains are ejected, a rear hole 121b via which air is supplied, and an abrasive grain supplying hole 121c which is formed between the front hole 121a and the rear hole 121b and via which the abrasive grains 12a are supplied.

The abrasive grain supplying hole 121c of the abrasive grain supplying nozzle 121 is connected to an abrasive grain tank 122 in which the abrasive grains are stored, and the rear hole 121b is connected to a high-speed electromagnetic valve 123.

The abrasive grain tank 122 has an opening/closing lid (not shown) in a part where the abrasive grain tank 122 is connected to the abrasive grain supplying nozzle 121, and the opening/closing lid opens only when the abrasive grains 12a are supplied.

The high-speed electromagnetic valve 123 has a connecting cylinder 123a that connects to the rear hole 121b of the abrasive grain supplying nozzle 121, and an air inlet hole 123b via which air supplied from an air supplying section (not shown) enters. The air which is supplied via the air inlet hole 123b is supplied to the connecting cylinder 123a while the high-speed electromagnetic valve 123 is being opened, whereas the air which is supplied via the air inlet hole 123b is not supplied to the connecting cylinder 123a while the high-speed electromagnetic valve 123 is being closed.

Therefore, according to the remedying head 12 arranged as above, the supplied air blows the abrasive grains 12a out from the abrasive grain supplying nozzle 121 while the high-speed electromagnetic valve 123 is being opened and the opening/closing lid of the abrasive grain tank 122 is being opened. Meanwhile, in a case where the high-speed electromagnetic nozzle 123 is closed, no abrasive grain 12a is jetted from the abrasive grain supplying nozzle 121 regardless of whether the opening/closing lid of the abrasive grain tank 122 is opened or closed. In a case where the high-speed electromagnetic valve 123 is opened and the opening/closing lid of the abrasive grain tank 122 is closed, air which contains no abrasive grain 12a, i.e., only air is jetted from the abrasive grain supplying nozzle 121.

The remedying head 12 arranged as above jets the abrasive grains 12a, which are made of alumina having No. 800 of abrasive grain size, toward the protrusion 1p of the surface 1s of the glass substrate 1 at processing speed of 0.2 mm/s to 0.6 mm/s (jetting speed of 150 m/s to 200 m/s) so that a glass material is removed until the abrasive grains 12a reach the internal bubble 1b serving as an internal defect.

Generally, after the abrasive grains 12a continue to be jetted from the remedying head 12 toward the surface 1a of the glass substrate 1, the abrasive grains 12a remains in a portion where the grinding process is carried out in the glass substrate 1. In such a case, newly jetted abrasive grains 12a collide with the abrasive grains 12a which remain in the portion, and therefore it is impossible to cause the abrasive grains 12a to directly grind a surface which is an actual target of the grinding process. This undesirably causes a reduction in grinding efficiency.

In view of this, air containing the abrasive grains 12a and only air are alternately jetted, the air serving as a medium used for jetting of the abrasive grains 12a. The abrasive grains 12a which remain in the portion where the grinding process is carried out in the glass substrate 1 can be removed by jetting only air. This allows an improvement in grinding efficiency. Specifically, air containing the abrasive grains 12a and air containing no abrasive grain 12a can be alternately jetted by alternately opening and closing the opening/closing lid of the abrasive grain tank 122 while the high-speed electromagnetic valve 123 is being opened.

For example, AJM (ABRASIVE Jet Machining: Sendai Nicon Corporation) can be used as the remedying head 12.

According to the defect remedying method of the present embodiment, the removal process can be carried out until a state shown in (b) of FIG. 1 is obtained, or until a state shown in (c) of FIG. 1 is obtained. FIG. 5 (a) shows a how the glass substrate 1 looks after the removal process is carried out until the state shown in (b) of FIG. 1 is obtained, and FIG. 5 (b) shows how the glass substrate 1 looks after the removal process is carried out until the state shown in (c) of FIG. 1 is obtained.

Each of the states shown in FIGS. 5 (a) and 5 (b) is not necessarily an ideal state from the viewpoint of a shape of the glass substrate 1. However, as a result of checking an actual effect on a display, it was more difficult to observe a bright dot due to the internal bubble 1b compared to the state where no removal process is carried out.

In the state shown in FIG. 5 (a), a glass material from the surface 1s of the glass substrate 1 to the internal bubble 1b is removed so that at least a part (part on the surface side) of glass surrounding the internal bubble 1b which causes a lens effect and a scattered polarization state is removed. It is considered that this reduces the lens effect and the scattered polarization state, thereby reducing occurrence of a bright dot.

In a state shown in FIG. 5 (b), even a glass material (surrounding section 1d) placed on a lateral side and a backside of the internal bubble 1b is removed, so that the grinding process is carried out until the revised surface 1e is exposed, i.e., until no lens effect and no scattered polarization state are caused. This further reduces the lens effect and the scattered polarization state.

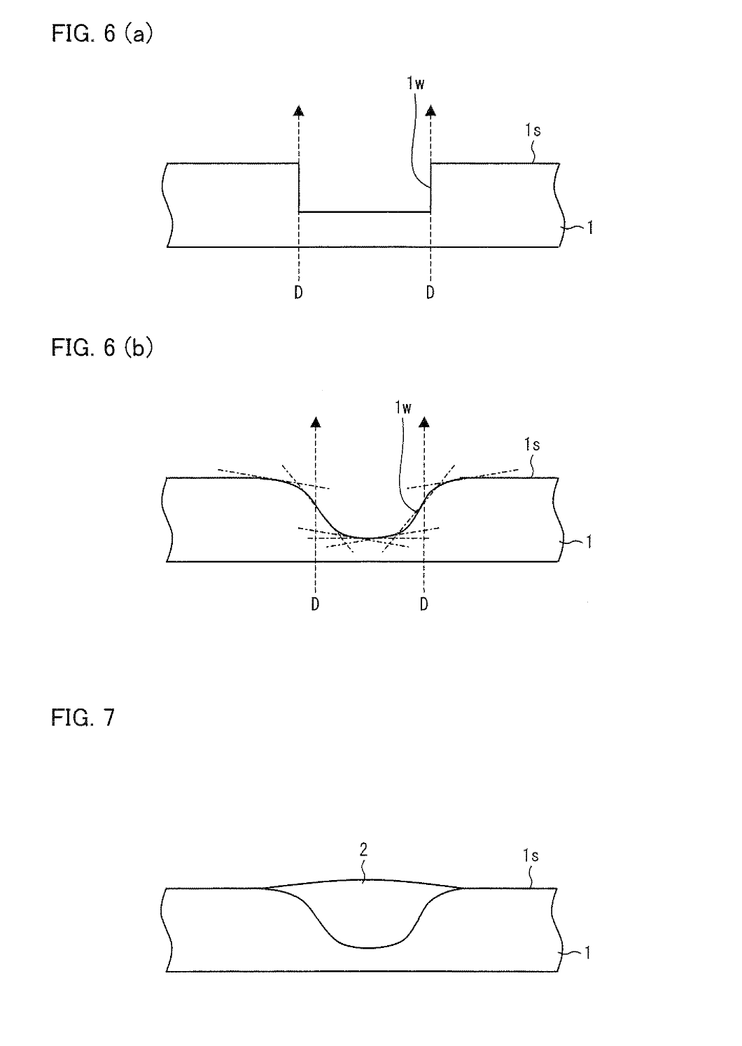

Next explained is a preferable processed shape. As illustrated in FIG. 6 (a), in a case where a recess having a steep shape in which a part of a processed surface 1w is vertical to the surface 1s is formed, in an observation direction D vertical to the surface 1s, the vertical part of the processed surface 1w is identical with the observation direction D. In this case, effects of the processed surface 1w on a display are accumulated in the observation direction D. As a result, this causes the processed surface 1w to be easily observed.

In contrast, in FIG. 6 (b), unlike the above one with a steep shape, the processed surface 1w is not vertical to the surface 1s, and a tangent plane, at any position on the processed surface 1w (illustrated by a dashed-dotted line in FIG. 6 (b)), is parallel or inclined with respect to the surface 1s. In this case, effects of the processed surface 1w on a display are not accumulated in the observation direction D. As a result, this allows the processed surface w1 to be hardly observed.

As such, it is preferable that the processed shape be such that the tangent plane, at any position in the processed surface 1w, is parallel or inclined with respect to the surface 1s, as shown in FIG. 6 (b). In order that such the processed shape is formed, jetting speed of the abrasive grains 12a jetted from the remedying head 12 may vary depending on a position to be remedied. For example, in order to obtain a recess having the shape shown in FIG. 6 (b), the jetting speed of the abrasive grains 12a is increased in a central portion of the recess, and the jetting speed of the abrasive grains 12a is gradually reduced as a distance becomes further from the central portion.

Further, it is preferable that the recess formed in the removal process be filled with a transparent material 2, as shown in FIG. 7. In a case where the recess is filled with the transparent material, it is possible to reduce a change in refractive index, compared with a state where the recess is not filled. This allows the recess to be hardly observed. In order that the recess formed in the removal process as such may be filled with the transparent material 2, the recess may be filled with a liquid transparent resin and then the liquid transparent resin may be solidified.

According to the defect remedying apparatus 10, alumina is used as the abrasive grains 12a. However, the abrasive grains 12a are not limited to this, and can be silicon carbide, boron carbide, or cerium oxide, for example. Further, the grain size of the abrasive grains 12a is not limited to No. 800, and therefore the abrasive grains 12a can have other grain size. It is more preferable that the glass substrate 1 is processed with the use of abrasive grains having grain size of No. 800, and then the process is finished with the use of abrasive grain having grain size of No. 2000. The grain size of the abrasive grains 12a may vary depending on an object to be subjected to the grinding process.

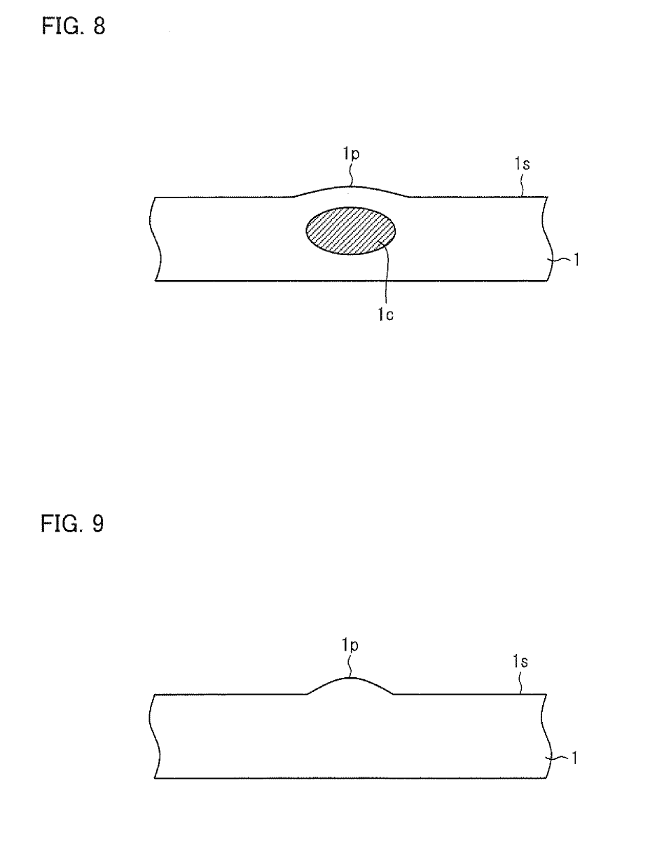

The above description has discussed a case where the glass substrate 1 that includes the internal bubble 1b as an internal defect is an object to be remedied, but a glass substrate 1 that includes an internal foreign matter 1c as an internal defect, as shown in FIG. 8, may be an object to be remedied. Even in this case, it is possible to realize a reduction in the lens effect or the scattered polarization state. Further, in a case where the internal foreign matter 1c is made from a light-shielding material, a process of fully removing the internal foreign matter 1c, as illustrated in FIG. 5 (b), makes it possible to obtain an effect that a black dot is removed.

The present embodiment has discussed an exemplary defect remedying method in which the internal bubble 1b or the internal foreign matter 1c formed in the glass substrate is an object to be remedied. However, the following Embodiment 2 discusses an example in which a protrusion which serves as a surface defect formed on the glass substrate is an object to be remedied, and is removed by the grinding process.

### Embodiment 2

The Embodiment 2 of the present invention is described below.

A defect remedying method of the present embodiment is for remedying a defect of a glass substrate for constituting a display panel, and the defect to be remedied is a protrusion which serves as a surface defect formed on the glass substrate. The protrusion may be formed due to an internal defect, as explained in Embodiment 1, or may be formed independently of such an internal defect.

As in the case of Embodiment 1, the defect remedying method of the present embodiment can be applied to a glass substrate for constituting various display panels such as a liquid crystal display panel, a plasma display panel (PDP), and the like.

Moreover, as in the case of Embodiment 1, the defect remedying method of the present embodiment can be carried out in various stages in producing a glass substrate or a display panel.

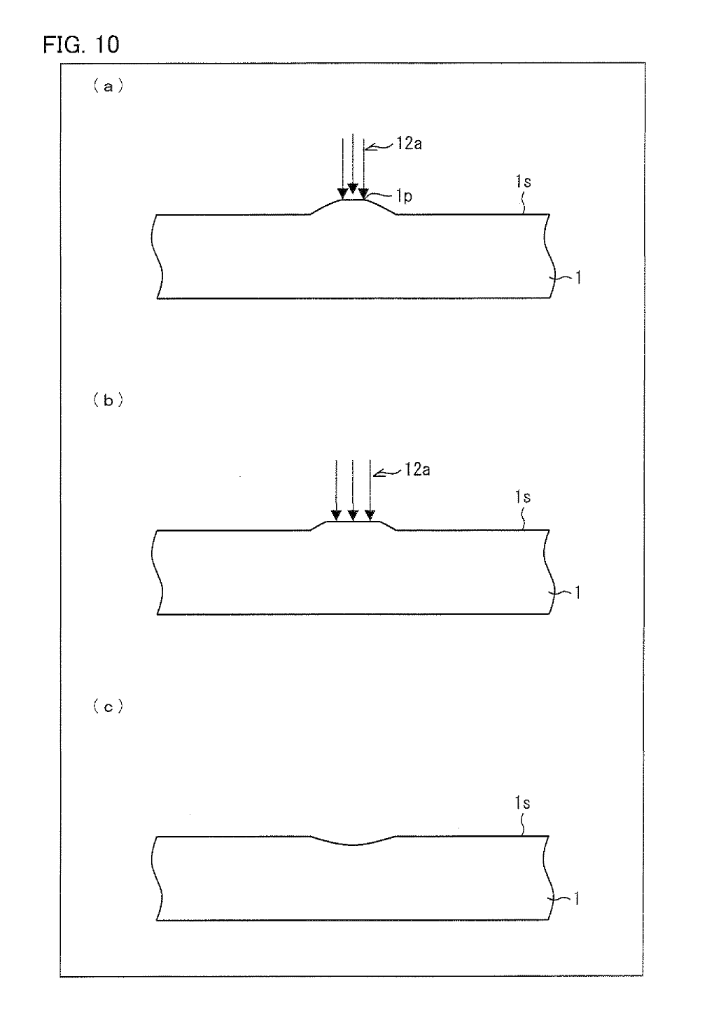

FIG. 9 is a cross-sectional view of a glass substrate 1 on which a protrusion 1p, serving as a surface defect to be remedied, is formed. As an apparatus for carrying out the defect remedying method of the present embodiment, the defect remedying apparatus 10 explained in Embodiment 1 can be used.

(a) through (c) of FIG. 10 each shows how a grinding process progresses. The abrasive grains 12a are jetted by the remedying head 12, and make contact with the protrusion 1p of the glass substrate 1, as shown in (a) of FIG. 10. Thus, the grinding process starts. After the abrasive grains 12a continue to be jetted, a height of the protrusion 1p becomes lowered as shown in (b) of FIG. 10. After the abrasive grains 12a further continue to be jetted, the protrusion 1p is fully removed as shown in (c) of FIG. 10.

In a case where the remedying head 12 is swayed in a horizontal direction with respect to the surface to be ground while the abrasive grains 12a are being jetted, then it is possible to substantially planarize the surface 1s, from which the protrusion 1p is removed.

According to the defect remedying method of the present embodiment, the removal process may be carried out until the state shown in (b) FIG. 10 is obtained, or until the state shown in (c) of FIG. 10 is obtained. As such, in the defect remedying method of the present embodiment, a part or all of the protrusion 1p is removed so that a height of the protrusion 1p is lowered. This is referred to as planarization of the protrusion 1p. This allows to approximate the surface 1s on which the protrusion 1p is formed, to a primary surface shape. As a result, a bright dot due to the protrusion 1p hardly occurs.

Note that, after the protrusion 1p is planarized, a slight recess may be formed in a part where the protrusion 1p was formed. In this case, as shown in FIG. 6 (b) in Embodiment 1, it is preferable that a processed shape of the recess be such that a tangent plane, at any position on a processed surface 1w, is parallel or inclined with respect to the surface 1s. Further, as shown in FIG. 7 in Embodiment 1, it is preferable that the recess thus formed be filled with a transparent material 2.

Alumina having grain size of No. 800 may be used as the abrasive grains 12a as in the Embodiment 1, and the abrasive grains 12a may be jetted at a processing speed of 0.2 mm/s to 0.6 mm/s (jetting speed of 150 m/s to 200 m/s). Note, however, that material, grain size, and jetting speed of the abrasive grains 12a may be changed according to need.

As described above, the present embodiment has discussed a case where the protrusion 1p is an object to be remedied in the glass substrate 1. However, the following Embodiment 3 discusses an example in which a scratch on a surface is an object to be remedied in the glass substrate 1.

### Embodiment 3

Embodiment 3 of the present invention is described below.

A defect remedying method of the present embodiment is a method for remedying a defect of a glass substrate for constituting a display panel, and the defect to be remedied is a scratch which serves as a surface defect formed on the glass substrate.

Further, as in the Embodiment 1, the defect remedying method of the present embodiment can be applied to a glass substrate for constituting various display panels such as a liquid crystal display panel, a plasma display panel (PDP), and the like.

Moreover, as in the Embodiment 1, the defect remedying method of the present embodiment can be carried out in various stages in producing a glass substrate or a display panel.

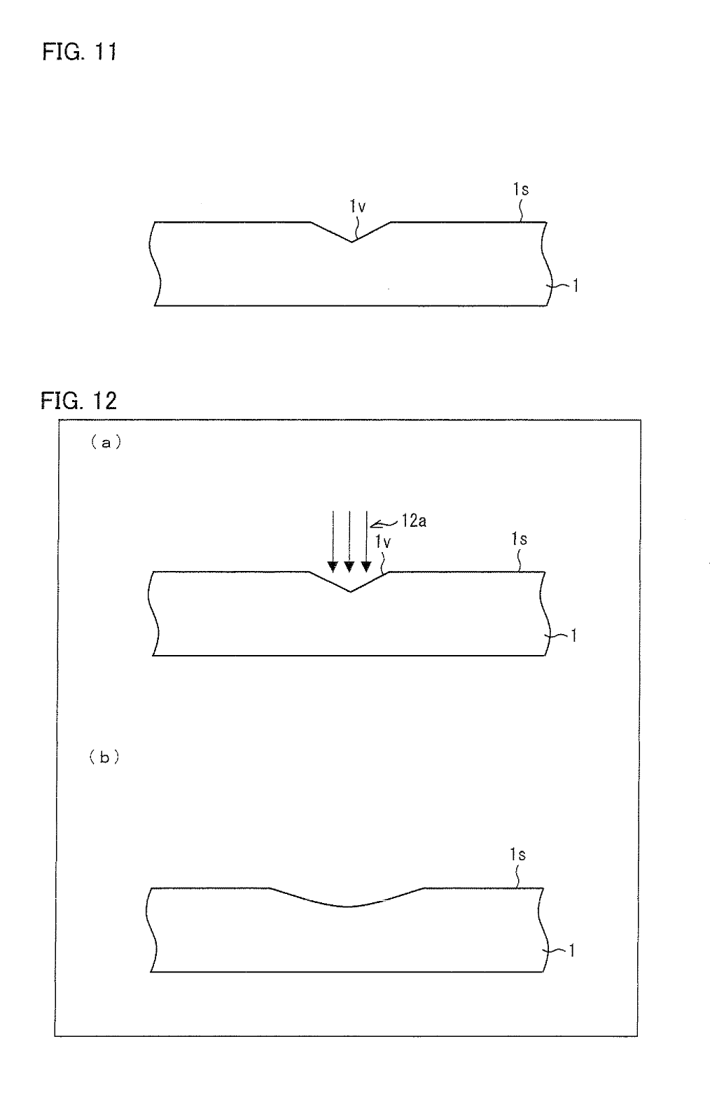

FIG. 11 is a cross-sectional view of a glass substrate 1 on which a scratch 1v, serving as a surface defect to be remedied, is formed. The defect remedying apparatus 10 described in the Embodiment 1 can be used as an apparatus for carrying out the defect remedying method of the present embodiment.

(a) and (b) of FIG. 12 each shows how a grinding process progresses. The abrasive grains 12a are jetted by the remedying head 12, and make contact with the surface 1s of the glass substrate 1, as shown in (a) of FIG. 12. Thus, the grinding process starts. The remedying head, 12 is swayed while the abrasive grains 12a are being jetted. This reduces an angle defined by a surface formed due to the scratch 1v and the primary surface 1s of the glass substrate 1, as shown in (b) of FIG. 12.

As such, in the defect remedying method of the present embodiment, the angle defined by the surface formed due to the scratch 1v and the primary surface is of the glass substrate 1 is reduced. This is referred to as smoothing of the scratch 1v. This allows to approximate the surface is on which the scratch 1v is formed, to a primary surface shape. As a result, a bright dot due to the scratch 1v hardly occurs.

Note that, it is preferable that a processed shape of a recess formed by smoothing the scratch 1 be such that a tangent plane, at any certain position on a processed surface 1w, is parallel or inclined with respect to the surface 1s, as shown in FIG. 6 (b) in the Embodiment 1. Further, as shown in FIG. 7 in the Embodiment 1, it is preferable that the recess thus formed be filled with a transparent material 2.

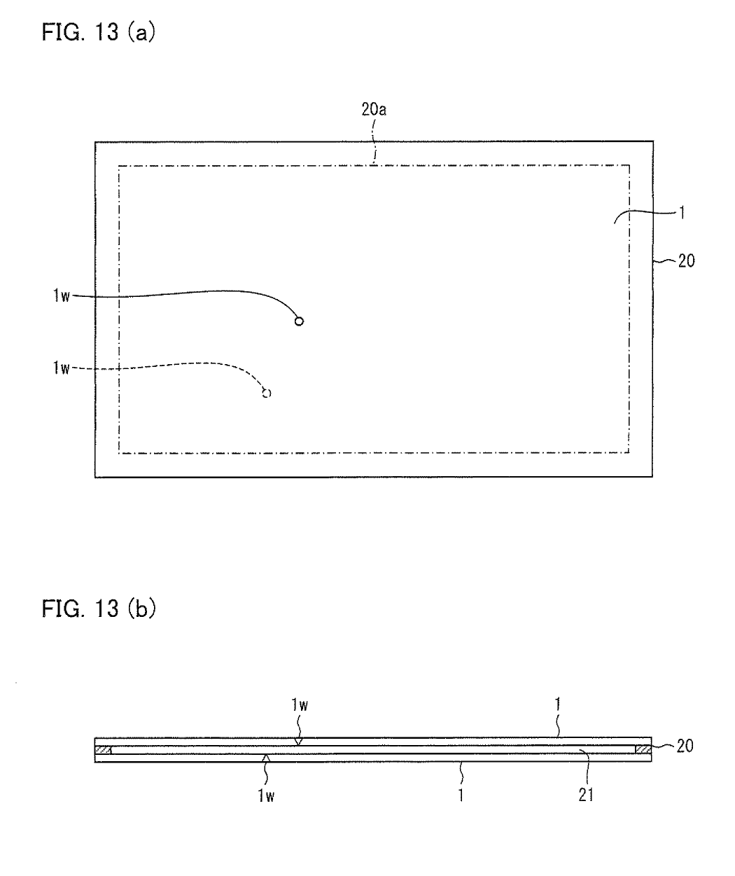

FIGS. 13 (a) and 13 (b) each shows a liquid crystal display panel 20 serving as a display panel that is constituted by use of the glass substrate 1 described in the Embodiments 1 through 3.

The liquid crystal display panel 20 is arranged such that (i) two glass substrates 1 are provided so as to face each other at a predetermined space provided therebetween, and (ii) a liquid crystal 21 is sandwiched between the two glass substrates 1 and is sealed. Note that a polarization plate and the like (not shown) are attached to external surfaces of the two glass substrates 1.

The two glass substrates 1 include, on a surface in a display area 20a of the liquid crystal display panel 20, a processed surface 1w which has been subjected to the glass material removal process described in the Embodiments 1 through 3. Note, however, that each of the two glass substrates 1 may include the processed surface 1w, or any one of the two glass substrates 1 may include the processed surface 1w. Further, it is preferable that the processed surface 1w is filled with a transparent material.

In the liquid crystal display panel 20, an internal defect or a surface defect formed in the two glass substrates 1 is subjected to any of the removal processes described in the Embodiments 1 through 3. As a result, adverse affects on a display are reduced. On this account, even the liquid crystal display panel 20 that has been conventionally deemed as a defective product can be produced as a good-quality product.

Each of the Embodiments has discussed an example in which abrasive grains, i.e., powder is jetted with the use of air so as to grind an object to be remedied. Note, however, that fluid, i.e., water can be jetted instead of powder so as to grind an object to be remedied. In this case, a head for jetting water is used as the remedying head 12.

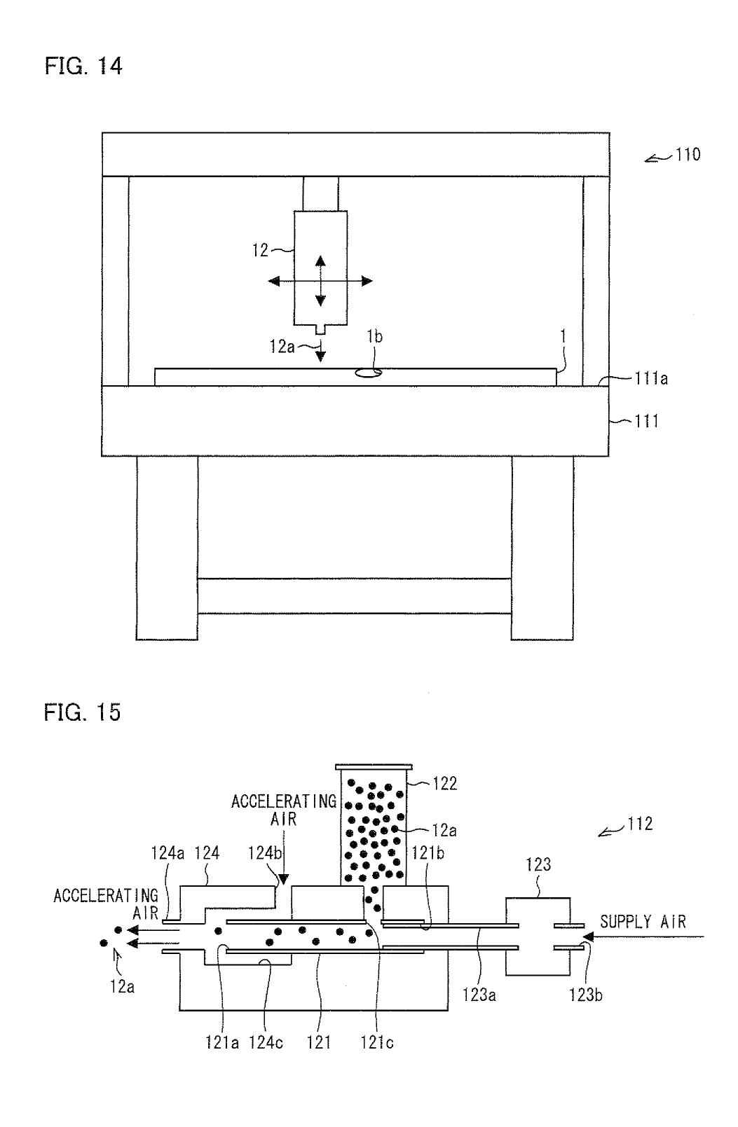

Further, each of the Embodiments has discussed an example in which the remedying head 12 provided in the defect remedying apparatus 10 is arranged such that the abrasive grains 12a are jetted in a horizontal direction with respect to the ground. However, this is not the only possibility. For example, a defect remedying apparatus 110 may be used. In the defect remedying apparatus 110, a remedying head 12 is arranged such that the abrasive grains 12a are jetted in a vertical direction with respect to the ground, as shown in FIG. 14.

The defect remedying apparatus 110 includes: a housing 111 having a placing surface 111a on which the glass substrate 1 is placed; and the remedying head 12 which is suspended from a ceiling of the housing 111 and which is movable in horizontal and vertical directions.

The defect remedying apparatus 10 moves the remedying head 12 toward a position above an internal bubble 1b of the glass substrate 1, and then causes the remedying head 12 to jet the abrasive grains 12a toward a surface 1s of the glass substrate 1 so as to carry out grinding process.

Further, according to the remedying head 12, only supply air is supplied, and therefore controlling supply of the supply air is directly linked with starting/stopping of jetting of the abrasive grains 12a. However, in order to jet only air containing no abrasive grain 12a, it is still necessary to control opening/closing of the opening/closing lid of the abrasive grain tank 122.

FIG. 15 shows a remedying head in which it is unnecessary to control opening/closing of the opening/closing lid of the abrasive grain tank 122 in order to jet only air containing no abrasive grain 12a.

A remedying head 112 shown in FIG. 15 is obtained by adding an accelerating nozzle 124 to the remedying head 12 shown in FIG. 4. Thus, accelerating air is supplied in addition to the supply air. Other constituents of the remedying head 112 are identical with those of the remedying head 12 shown in FIG. 4.

The remedying head 112 is arranged such that the accelerating nozzle 124 for accelerating the abrasive grains 12a supplied by the abrasive grain supplying nozzle 121 is newly added, as shown in FIG. 15.

The accelerating nozzle 124 has (i) a jetting hole 124a via which the abrasive grains 12a are jetted toward outside, (ii) an air supplying hole 124b via which the accelerating air, which accelerates the abrasive grains 12a and causes the abrasive grains 12a to be jetted from the jetting hole 124a, is supplied, and (iii) a mixing room 124c which is formed between the jetting hole 124a and the air supplying hole 124b, in which the abrasive grains 12a and the accelerating air are mixed, and which guides the mixture to the jetting hole 124a.

The front hole 121a of the abrasive grain supplying nozzle 121 is disposed so as to protrude into the mixing room 124c of the accelerating nozzle 124.

Therefore, according to the remedying head 112 arranged as above, in a case where the high-speed electromagnetic valve 123 is opened, the abrasive grains 12a are supplied from the abrasive grain supplying nozzle 121 to the accelerating nozzle 124 with the use of the supply air, and then air containing the abrasive grains 12a is jetted from the jetting hole 124a with the use of the accelerating air supplied from the air supplying hole 124b. Meanwhile, in a case where the high-speed electromagnetic valve 123 is closed, the supply air is not supplied to the abrasive grain supplying nozzle 121, and therefore the abrasive grains 12a are not supplied to the accelerating nozzle 124. Consequently, only air that contains no abrasive grain 12a is jetted from the jetting hole 124a of the accelerating nozzle 124.

Note that supply of the accelerating air and the supply air is controlled so that P1<P2 is satisfied where P1 is pressure of the accelerating air and P2 is pressure of the supply air. With this arrangement, the abrasive grains 12a in the abrasive grain supplying nozzle 121 are always supplied to the accelerating nozzle 124, and backflow of the abrasive grains 12a does not occur.

Generally, after the abrasive grains 12a continue to be jetted from the remedying head 112 toward the surface la of the glass substrate 1, the abrasive grains 12a remains in a portion that is subjected to a grinding process. In such a case, newly jetted abrasive grains 12a collide with the abrasive grains 12a which remain in the portion, and therefore it is impossible to cause the abrasive grains 12a to directly grind a surface which is an actual target of the grinding process. This undesirably causes a reduction in grinding efficiency.

In view of this, a pulse-shaped drive signal may be supplied to the high-speed electromagnetic valve 124 of the remedying head 112 so that air supplied from the air inlet hole 123b is intermittently supplied to the connecting cylinder 123a and so that the abrasive grains 12a are intermittently supplied from the abrasive grain supplying nozzle 121 to the accelerating nozzle 124. According to the arrangement, air containing the abrasive grains 12a and air containing no abrasive grain 12a, i.e., only air are alternately jetted, the air serving as a medium used for jetting of the abrasive grains 12a. Therefore, the abrasive grains 12a which remain in the portion that is subjected to the grinding process can be removed by jetting only air. This allows an improvement in grinding efficiency.

Note that, as with the remedying head 12 shown in FIG. 4, the remedying head 112 shown in FIG. 15 can be provided in any of the defect remedying apparatus 10 shown in FIG. 3 and the defect remedying apparatus 110 shown in FIG. 14.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be suitably applied to flat display panels such as a liquid crystal display panel and a plasma display panel (PDP).

1. A method for remedying a target defect of a glass substrate for constituting a display panel, comprising:
removing a glass material in a region including the target defect, by jetting at least one of powder and fluid toward a portion where the target defect is located.

2. The method according to claim 1, wherein
in a case where the target defect is an internal defect formed in the glass substrate,
the step of removing removes the glass material, from a surface of the glass substrate to the internal defect at least, by jetting at least one of the powder and the fluid toward a portion where the internal defect is located.

3. The method according to claim 2, wherein
the step of removing also removes a glass material surrounding the internal defect.

4. The method according to claim 1, wherein
the internal defect is an internal bubble.

5. The method according to claim 1, wherein
in a case where the target defect is a protrusion formed on the glass substrate,
the step of removing removes the glass material so that a surface of the glass substrate is planarized by jetting at least one of the powder and the fluid toward a portion where the protrusion is located.

6. The method according to claim 1, wherein
in a case where the target defect is a scratch formed on the glass substrate,
the step of removing removes the glass material so that a surface of the glass substrate is smoothed by jetting at least one of the powder and the fluid toward a portion where the scratch is located.

7. The method according to claim 5, wherein
the step of removing also removes a glass material surrounding the protrusion or the scratch formed on the surface of the glass substrate.

8. The method according to claim 1, wherein the powder is alumina.

9. The method according to claim 1, wherein
in a case where the glass material is removed by jetting the powder,
in the step of removing, (i) air which contains the powder and (ii) only air are jetted alternately, the air serving as a medium for jetting of the powder.

10. The method according to claim 1, comprising:
filling with a transparent material a portion from which the glass material is removed.

11. he method according to claim 1, wherein
the glass substrate is for constituting a liquid crystal display panel.

12. A method for manufacturing a glass substrate for constituting a display panel, comprising
removing a glass material in a region including a target defect formed on the glass substrate by jetting at least one of powder and fluid toward a portion where the target defect is located.

13. The method according to claim 12, wherein
in a case where the target defect is an internal defect formed in the glass substrate,
the step of removing removes the glass material, from a surface of the glass substrate to the internal defect at least, by jetting at least one of the powder and the fluid toward a portion where the internal defect is located.

14. The method according to claim 13, wherein
the step of removing also removes a glass material surrounding the internal defect.

15. The method according to claim 12, wherein
the internal defect is an internal bubble.

16. The method according to claim 12, wherein
in a case where the target defect is a protrusion formed on the glass substrate,
the step of removing removes the glass material so that a surface of the glass substrate is planarized by jetting at least one of the powder and the fluid toward a portion where the protrusion is located.

17. The method according to claim 12, wherein
in a case where the target defect is a scratch formed on the glass substrate,
the step of removing removes the glass material so that a surface of the glass substrate is smoothed by jetting at least one of the powder and the fluid toward a portion where the scratch is located.

18. The method according to claim 16, wherein
the step of removing also removes a glass material surrounding the protrusion or the scratch formed on the surface of the glass substrate.

19. The method according to claim 12, wherein
the powder is alumina.

20. The method according to claim 12, wherein
in a case where the glass material is removed by jetting the powder,
in the step of removing, (i) air which contains the powder and (ii) only air are jetted alternately, the air serving as a medium for jetting of the powder.

21. The method according to claim 12, further comprising
filling with a transparent material a portion from which the glass material is removed.

22. The method according to claim 12, wherein
the glass substrate is for constituting a liquid crystal display panel.

23. A glass substrate for constituting a display panel, wherein:
in a surface of a display area of the display panel, which display area is obtained when the display panel is constituted by the glass substrate, the glass substrate includes a region (i) to which at least one of powder and fluid is jetted so that a removal process in which a glass material is removed is carried out, (ii) in which a transparency is maintained, and (iii) in which a recess is formed.

24. The glass substrate according to claim 23, wherein the recess is filled with a transparent material.

25. A display panel including a glass substrate for display, wherein:
in a surface of a display area of the display panel, which display area is obtained when the display panel is constituted by the glass substrate, the glass substrate includes a region (i) to which at least one of powder and fluid is jetted so that a removal process in which a glass material is removed is carried out, (ii) in which a transparency is maintained, and (iii) in which a recess is formed.

26. The display panel according to claim 25, wherein
the recess is filled with a transparent material.
